(19) United States
(12) Patent Application Publication
(10) Pub. No.: US 2025/0392973 A1
(43) Pub. Date: Dec. 25, 2025

(54) WTRU MOBILITY AND CELL RESELECTION IN ENERGY SAVINGS NETWORKS

(71) Applicant: InterDigital Patent Holdings, Inc., Wilmington, DE (US)

(72) Inventors: Oumer Teyeb, Montreal (CA); Faris Alfarhan, Montreal (CA); Paul Marinier, Brossard (CA); Moon-il Lee, Melville, NY (US); Ananth Kini, Conshohocken, PA (US); Ghyslain Pelletier, Montreal (CA)

(73) Assignee: InterDigital Patent Holdings, Inc., Wilmington, DE (US)

(21) Appl. No.: 19/101,182

(22) PCT Filed: Aug. 4, 2023
(86) PCT No.: PCT/US2023/029523

§ 371 Date: Feb. 4, 2025

Related U.S. Application Data
(60) Provisional application No. 63/395,183, filed on Aug. 4, 2022.
(60) Provisional application No. 63/410,081, filed on Sep. 26, 2022.

(51) Int. Cl. H04W 36/22; H04W 52/02; H04W 76/28; H04W 76/40

(52) U.S. Cl. CPC H04W 36/22; H04W 52/0235; H04W 76/28; H04W 76/40

(57) ABSTRACT

Systems, methods, and instrumentalities are described herein for WTRU mobility and cell reselection in energy savings networks. Handover associated with network energy savings (NES) may be performed. A wireless transmit/receive unit (WTRU) may perform a handover from a source cell to a target cell, for example, based on determining that the source cell is entering an NES state and based on determining that a handover condition is satisfied. The WTRU may determine that the handover condition is satisfied but refrain from performing handover until a determination that the source cell is entering an NES state.

### CROSS-REFERENCE TO RELATED APPLICATIONS

The application claims the benefit of U.S. Provisional Application 63/395, 183, filed Aug. 4, 2022 and U.S. Provisional Application 63/410,081, filed Sep. 26, 2022, the contents of which are incorporated by reference in their entirety herein.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for WTRU mobility and cell reselection in energy savings networks. Handover associated with network energy savings (NES) may be performed. A wireless transmit/receive unit (WTRU) may perform a handover from a source cell to a target cell, for example, based on determining that the source cell is entering an NES state and based on determining that a handover condition is satisfied. The WTRU may determine that the handover condition is satisfied but refrain from performing handover until a determination that the source cell is entering an NES state.

The WTRU may receive configuration information (e.g., NES-specific configuration information). The configuration information may include a set of handover candidates (e.g., cell candidates). The configuration information may include an NES conditional handover condition(s). The WTRU may determine that the source cell is entering an NES state (e.g., state associated with cell discontinuous transmission, cell turn off state, etc.). The WTRU may determine that the source cell is entering an NES state, for example, based on an indication. The indication may indicate that the source cell is entering an NES state, and the indication may indicate a time associated with entering the NES state. The WTRU may determine that the source cell is entering an NES state based on measurement(s) associated with the source cell. The WTRU may determine that the source cell is entering an NES state based on a determination that a measurement associated with the source cell is less than a threshold. The WTRU may determine that the source cell is entering an NES state based on a determination that a change in measurements associated with the source cell is greater than the threshold (e.g., a difference between a first measurement and second measurement for a source cell is greater than a threshold).

The handover candidates included in the configuration information may include a first handover candidate and a second handover candidate. The first handover candidate may be associated with a first priority, and the second handover candidate may be associated with a second priority. The configuration information may indicate that the first handover candidate is prioritized over the second handover candidate (e.g., first priority value is associated with a higher priority as compared with the second priority value). The WTRU may determine that the first handover cell and the second handover cell both satisfy a handover condition (e.g., the first handover cell and the second handover cell are both available for selection). The WTRU may perform the handover to the first handover cell, for example, based on the first handover candidate being indicated as being prioritized over the second handover candidate.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of the time-frequency structure of an SSB.

FIG. 3 illustrates an example of beam sweeping.

FIG. 4 illustrates an example of a conditional handover configuration and execution.

FIG. 5 illustrates an example of NES-specific CHO and execution.

### EXAMPLE NETWORKS FOR IMPLEMENTATION OF THE EMBODIMENTS

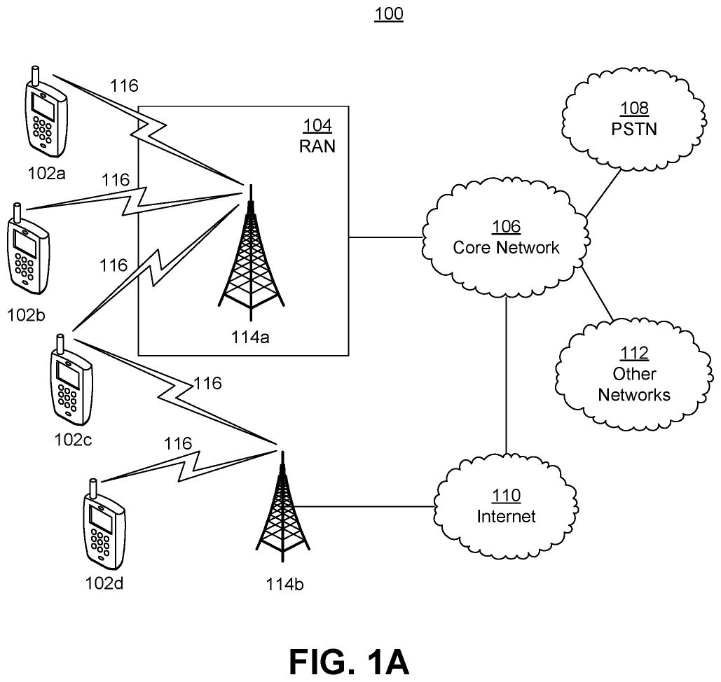

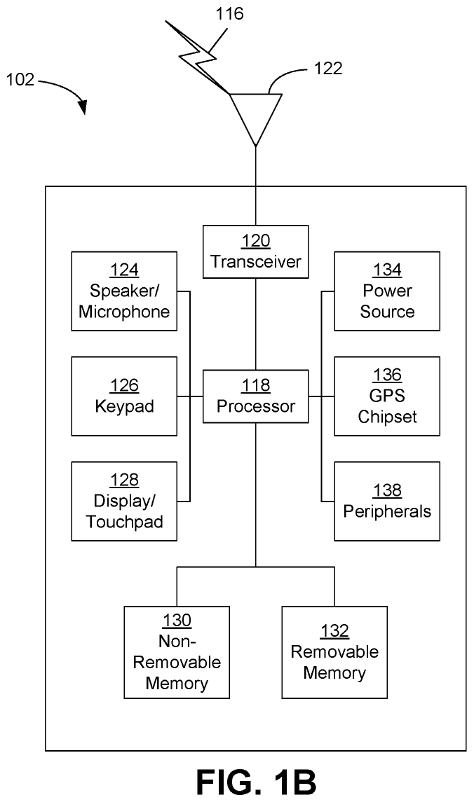

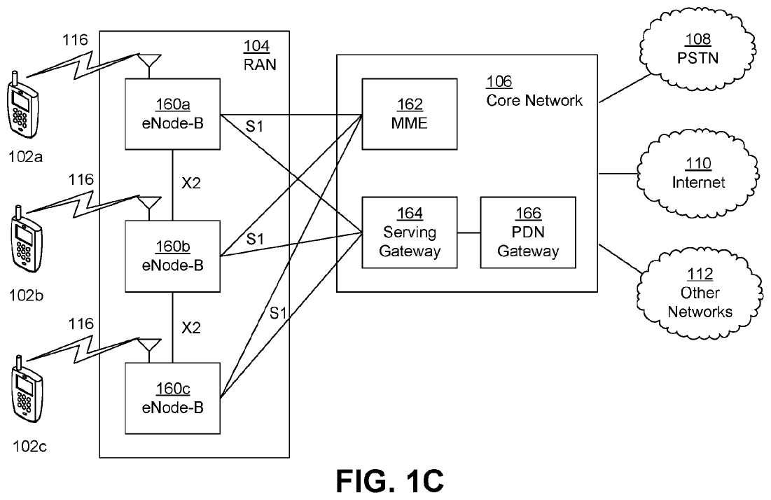

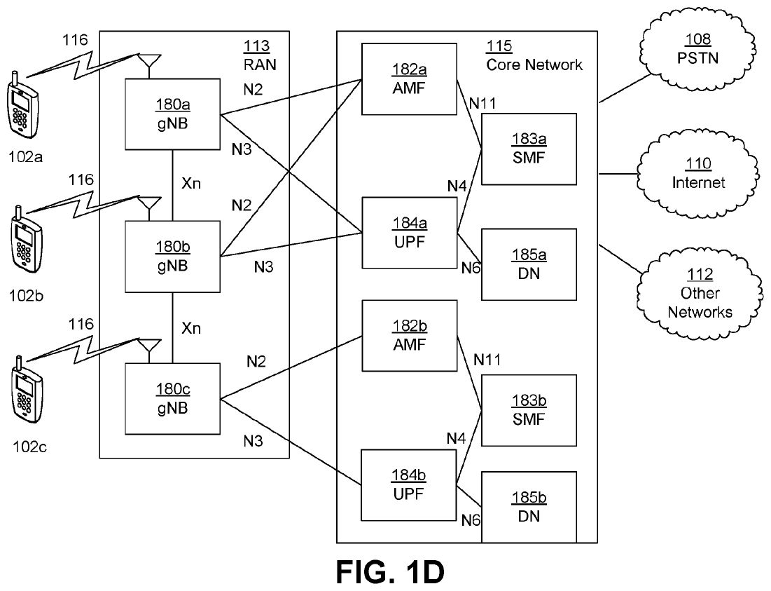

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c, 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VolP) services to one or more of the WTRUs 102a, 102b, 102c, 102d. The data may have varying quality of service (QOS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102cwith access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHZ, 80 MHZ, and/or 160 MHz wide channels. The 40 MHZ, and/or 80 MHZ, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHZ, 2 MHZ, 4 MHZ, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHZ, 4 MHZ, 8 MHZ, 16 MHZ, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 125a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Systems, methods, and instrumentalities are described herein for WTRU mobility and cell reselection in energy savings networks. Handover associated with network energy savings (NES) may be performed. A wireless transmit/receive unit (WTRU) may perform a handover from a source cell to a target cell, for example, based on determining that the source cell is entering an NES state and based on determining that a handover condition is satisfied. The WTRU may determine that the handover condition is satisfied but refrain from performing handover until a determination that the source cell is entering an NES state.

The WTRU may receive configuration information (e.g., NES-specific configuration information). The configuration information may include a set of handover candidates (e.g., cell candidates). The configuration information may include an NES conditional handover condition(s). The WTRU may determine that the source cell is entering an NES state (e.g., state associated with cell discontinuous transmission, cell turn off state, etc.). The WTRU may determine that the source cell is entering an NES state, for example, based on an indication. The indication may indicate that the source cell is entering an NES state, and the indication may indicate a time associated with entering the NES state. The WTRU may determine that the source cell is entering an NES state based on measurement(s) associated with the source cell. The WTRU may determine that the source cell is entering an NES state based on a determination that a measurement associated with the source cell is less than a threshold. The WTRU may determine that the source cell is entering an NES state based on a determination that a change in measurements associated with the source cell is greater than the threshold (e.g., a difference between a first measurement and second measurement for a source cell is greater than a threshold).

The handover candidates included in the configuration information may include a first handover candidate and a second handover candidate. The first handover candidate may be associated with a first priority, and the second handover candidate may be associated with a second priority. The configuration information may indicate that the first handover candidate is prioritized over the second handover candidate (e.g., first priority value is associated with a higher priority as compared with the second priority value). The WTRU may determine that the first handover cell and the second handover cell both satisfy a handover condition (e.g., the first handover cell and the second handover cell are both available for selection). The WTRU may perform the handover to the first handover cell, for example, based on the first handover candidate being indicated as being prioritized over the second handover candidate.

WTRU mobility and/or carrier reselection may be implemented for WTRUs configured to operate in networks configured for energy savings operation(s). Examples of connected mode procedures and behaviors are described for WTRUs operating in network energy savings (NES) cells, e.g., including mobility, carrier switching, and/or secondary cell (SCell) operation. Examples of idle/inactive mode procedures/behaviors are described for WTRUs, such as cell re-selection.

In examples of mobility, a group handover for WTRUs may be served by a (e.g., the same) turned-off cell, bandwidth part (BWP), or gNB. For example, a group common command (e.g., L1, L2, or broadcast signaling) may be used to perform mobility. A conditional handover (CHO) triggering condition may be based on the detection of a change of the power saving mode of a neighbor and/or a serving cell. A gradual HO/CHO may be based on a time duration left for a change of a power saving mode of a neighbor and/or serving cell, for example, to prevent overload at a target cell/node (e.g., random access channel (RACH) overload). An offset may be added to idle/inactive/connected mode mobility thresholds, for example, if (e.g., when) a WTRU determines that a serving cell and/or a target cell is (are) in a power saving mode. L1 signaling (e.g., common L1 signaling) may indicate to one or more (e.g., a group of) WTRUs to switch off or mute a transmission/reception point (TRP), perform a handover to another TRP, and/or stop monitoring associated transmission configuration index (TCI) states. Example procedures are described for performing a random access (RA) towards a target cell in a power saving/sleep mode/state.

In examples of cell switching and (re) selection, example procedures are described for SCell operation without synchronization signal block (SSB) transmission/cross carrier synchronization.

A radio access network (e.g., 3GPP RAN) may implement network energy savings (NES). A network may minimize its power consumption for transmission and/or reception. Minimization of power consumption may be beneficial to reduce operational costs and improve environmental sustainability.

A network may be (e.g., very) efficient, for example, from the perspective of minimizing transmissions from the network if (e.g., when) there is no data. A network may refrain from utilizing (e.g., not utilize) an always-on cell-specific reference signal (CRS). Energy consumption may be (e.g., additionally and/or alternatively) reduced, for example, as described herein.

For example, a network may consume energy if (e.g., when) refraining from (e.g., not) transmitting for other activities, such as baseband (e.g., digital) processing for reception or beamforming. Such “idle” power consumption may not be negligible in dense networks, e.g., even when there are not any WTRUs being served during a given period. Energy consumption may be reduced, for example, if the network turns off these activities when not transmitting to a WTRU.

A network may support beamforming with multiple (e.g., many) ports (e.g., up to 64 transmit and receive ports). Energy consumption may increase with the number of ports utilized. The utilization of a maximum number of ports may not be necessary for all WTRUs. Energy consumption may be reduced, for example, if the network can adapt the number of ports (e.g., to only the number of ports required).

Network energy savings may improve the operation of the cellular eco-system to enable more efficient adaptation of network transmissions and receptions resources in the time, frequency, spatial, and power domains, e.g., with support, feedback, and/or other assistance from WTRUs. An echo-friendly WTRU operation may support deployment of greener network deployments that allow reduced emissions and/or reduced operating expense (OPEX) costs of operating cellular networks. Some networks may (e.g., unlike other networks) refrain from using (e.g., not require) transmission of always-on synch or reference signals and/or may support adaptable bandwidth and multiple input multiple output (MIMO) capabilities. Power conservation may be implemented without impacting some WTRUs (e.g., legacy WTRUs). Adaptation of network resources may enable greater efficiency in operating newer deployments and later generations.

Channel state information (CSI) may include, for example, one or more of the following: a channel quality index (CQI), a rank indicator (RI), a precoding matrix index (PMI), an L1 channel measurement (e.g., a reference signal received power (RSRP), such as an L1-RSRP, or a signal interference to noise ratio (SINR)), a channel state information reference signal (CSI-RS) resource indicator (CRI), a synchronization signal (SS)/physical broadcasting channel (PBCH) block resource indicator (SSBRI), a layer indicator (LI), and/or any other measurement quantity measured by a WTRU from the configured CSI-RS or SS/PBCH block.

Uplink control information (UCI) may include, for example, a CSI, hybrid automatic repeat request (HARQ) feedback for one or more HARQ processes, a scheduling request (SR), a link recovery request (LRR), a configured grant UCI (CG-UCI), and/or other control information bits that may be transmitted on a physical uplink control channel (PUCCH) or a physical uplink shared channel (PUSCH).

Channel conditions may include a (e.g., any) condition(s) relating to the state of a radio/channel, which may be determined by a WTRU, for example, from one or more of the following: a WTRU measurement (e.g., L1/SINR/RSRP, a channel quality indicator (CQI)/modulation and coding scheme (MCS), channel occupancy, a received signal strength indicator (RSSI), power headroom, exposure headroom), L3/mobility-based measurements (e.g., RSRP, reference signal received quality (RSRQ)), a radio link monitoring (RLM) state, and/or channel availability in unlicensed spectrum (e.g., whether the channel is occupied based on determination of a listen-before-talk (LBT) procedure or whether the channel is deemed to have experienced a consistent LBT failure).

A physical random access channel (PRACH) resource may include one or more of the following: a PRACH resource (e.g., in frequency), a PRACH occasion (RO) (e.g., in time), a preamble format (e.g., in terms of total preamble duration, sequence length, guard time duration, and/or in terms of length of cyclic prefix), and/or a (e.g., certain) preamble sequence that may be used for the transmission of a preamble in a random access procedure.

A property of scheduling information (e.g., an uplink grant or a downlink assignment) may include, for example, one or more of the following: a frequency allocation; an aspect of time allocation, such as a duration; a priority; a modulation and coding scheme; a transport block size; a number of spatial layers; a number of transport blocks to be carried; a TCI state or SRI; a number of repetitions; and/or an indication whether the grant is a configured grant type 1, type 2 or a dynamic grant.

An indication by downlink control information (DCI), and/or another indication, may include, for example, one or more of the following: an (e.g., explicit) indication by a DCI field or by a radio network identifier (RNTI) used to mask a cyclic redundancy check (CRC) of the physical downlink control channel (PDCCH); an (e.g., implicit) indication by a property, such as a DCI format, a DCI size, a control resource set (CORESET) and/or search space, an aggregation level, an identity of a first control channel resource (e.g., index of a first control channel element (CCE) for a DCI, e.g., where a mapping between a property and a value may be signaled by radio resource control (RRC) or medium access control (MAC); and/or an (e.g., explicit) indication by a downlink (DL) MAC control element (CE).

The terms network availability state and network energy savings (NES) state may be used interchangeably.

Networksystem information (SI) may be provided. System Information (SI) may include, for example, a master Information block (MIB) and/or a number of system information blocks SIBs). The SIBs may be divided into a minimum SI and other SI.

A minimum SI may carry information that may be used for initial access and/or for acquiring any other SI. A minimum SI may include, for example, an MIB and SIB1. A WTRU may acquire the contents of a minimum SI of a cell, for example, for the WTRU to (e.g., be allowed to) camp on the cell.

Other SI may include (e.g., all) SIBs not broadcasted in the minimum SI. A WTRU may receive or may refrain from receiving (e.g., not receive) the SIBs before accessing the cell. Other SI may be referred to as an On-Demand SI, for example, because the base station (e.g., gNB) may transmit/broadcast SIBs on request (e.g., only when explicitly requested by WTRU(s). Transmission (e.g., only) upon request may reduce network energy consumption.

An MIB may include cell barred status information and/or (e.g., essential) physical layer information of the cell configured (e.g., required) to receive further system information, e.g., CORESET #0 configuration information. An MIB may be (e.g., periodically) broadcast on a broadcast channel (BCH). In some examples, the periodicity of broadcast may be 80 ms. In some examples repetitive transmission may occur within the periodicity of broadcast (e.g., 80 mS period).

SIB1 may indicate (e.g., define) the scheduling of other system information blocks (SIBs). SIB1 may include information (e.g., required) for initial access. SIB1 may be referred to as remaining minimum SI (RMSI). SIB1 may be (e.g., periodically) broadcast on a DL shared channel (DL-SCH) and/or may be sent to WTRU(s) in a dedicated manner, e.g., on a DL-SCH to WTRUs in RRC_CONNECTED mode.

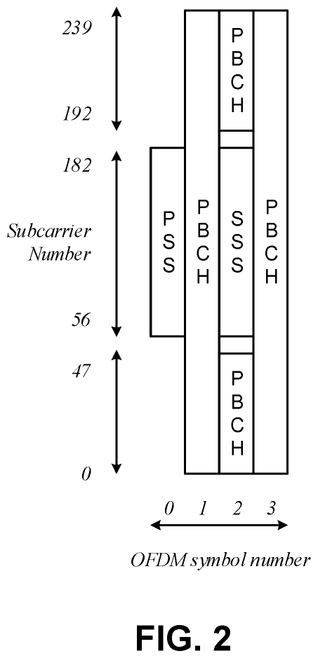

A synchronization signal and PBCH block may be provided. A synchronization signal and PBCH block (SSB) may include a primary synchronization signal (PSS) and/or a secondary synchronization signal (SSS). A PSS and/or an SSS may (e.g., each) occupy one (1) symbol and/or 127 subcarriers. A PBCH may span across three (3) orthogonal frequency division multiplexing (OFDM) symbols and/or 240 subcarriers. A symbol may leave an unused part (e.g., in the middle) for SSS, for example, as shown by example in FIG. 2.

FIG. 2 illustrates an example of the time-frequency structure of an SSB. The possible time locations of SSBs within a half-frame may be determined (e.g., configured by a network) based on sub-carrier spacing and/or the periodicity of the half-frames where SSBs are transmitted. Different SSBs may be transmitted (e.g., during a half-frame) in different spatial directions (e.g., using different beams, spanning the coverage area of a cell).

Multiple SSBs may be transmitted within the frequency span of a carrier. Physical layer cell identifiers (PCIs) of SSBs transmitted in different frequency locations may or may not be unique. In some examples, different SSBs in the frequency domain may have different PCIs. An SSB may be referred to as a cell-defining SSB (CD-SSB), for example, if (e.g., when) an SSB is associated with a remaining minimum SI (RMSI). A primary cell (PCell) may (e.g., always) be associated with a CD-SSB located on the synchronization raster.

A WTRU may assume a band-specific sub-carrier spacing for the SSB, for example, unless a network has configured the WTRU to assume a different sub-carrier spacing.

One or more (e.g., several) beams may be associated with a given cell or SSB. One or more (e.g., multiple) SSBs may be transmitted within a given cell on different beams (e.g., beam sweeping).

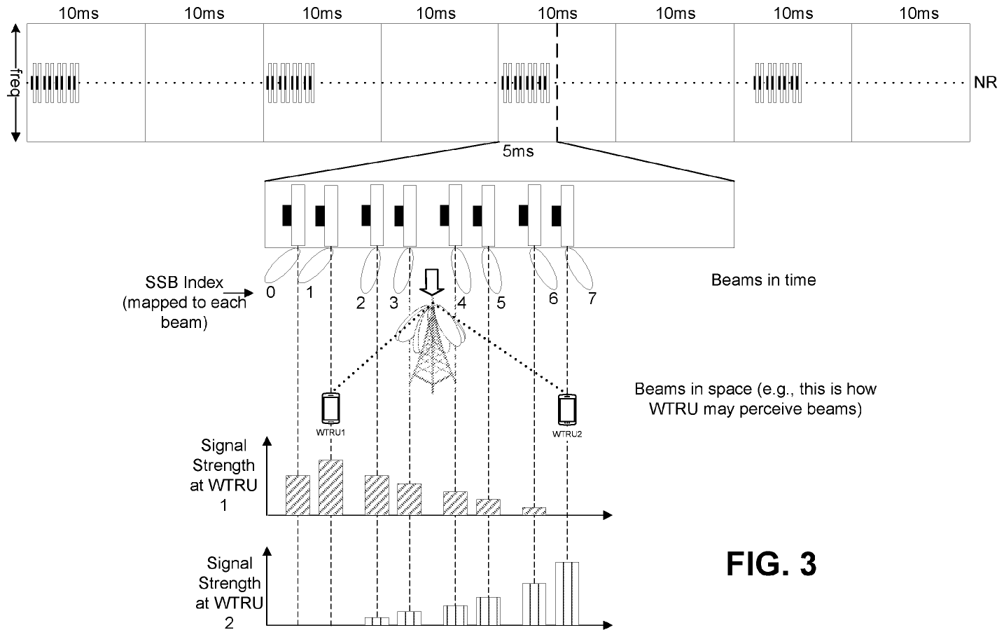

FIG. 3 illustrates an example of beam sweeping. In some examples (e.g., as shown in FIG. 3), multiple SSBs may be transmitted (e.g., with a certain interval). A (e.g., each) SSB may be identified by a (e.g., unique) number (e.g., an SSB index). A (e.g., each) SSB may be transmitted via a specific (e.g., selected) beam radiated in a certain (e.g., selected) direction. Multiple WTRUs may be located at various places around a base station (e.g., gNB). A WTRU may measure the signal strength of an (e.g., each) SSB that the WTRU detected. The measurement may occur for a certain period (e.g., a period of one SSB set). A WTRU may identify (e.g., from the measurement result(s)) the SSB index with the highest (e.g., strongest) signal strength. As shown by example in FIG. 3, Beam #1 may be the best beam (e.g., the selected beam) for WTRU1 and Beam #7 may be the best beam for WTRU2.

The number of different beams transmitted may be determined by how many SSBs are transmitted within an SSB burst set (e.g., a set of SSBs being transmitted in a 5 ms window of SSB transmission). In some examples, the maximum number of SSBs within an SSB set for a first frequency range (FR1) may be 4 or 8, while the maximum number of SSBs within an SSB set for a second frequency range (FR2) may be 64.

Network availability states and/or NES states may be provided (e.g., indicated, determined, selected, etc.). A WTRU may determine whether to transmit or receive on certain (e.g., one or more) resources, for example, based on a network availability state, which may imply the gNB's power savings status. An availability state may correspond to a network energy savings state or a gNB activity level. An availability state may be uplink and/or downlink specific. An availability state may change from symbol to symbol, slot to slot, frame to frame, and/or on longer duration granularity. An availability state may be determined by the WTRU or indicated by a network (NW). An availability state may be, for example, “on,” “off,” “reduced Tx power,” “dormant,” “micro sleep,” or “deep sleep.” Availability states may be abstracted by NW configuration parameters and/or values. An “Off” availability state may indicate (e.g., imply) that the gNB's baseband hardware is (e.g., completely) turned off. A “sleep” availability state may indicate that the gNB may wake up (e.g., periodically) to transmit certain (e.g., one or more) signals (e.g., presence signals, synchronization, or reference signals) and/or receive certain UL signals. In some examples, one or more availability states may have one or more DL and/or UL resources that are not available (e.g., during certain periods of time), which may enable the network to turn off baseband processing and/or other activities (e.g., to reduce power consumption). Some measurement resources (e.g., SSBs or CSI-RS) may (e.g., only) be made available in one or more (e.g., certain) availability states.

A WTRU may (e.g., under certain conditions) transmit a request to the network (e.g., a wake-up request) to modify the availability state to a state that makes one or more resources available for the WTRU. A wake-up request may include a transmission that may be decodable by a (e.g., low-complexity) receiver at the gNB (e.g., for which energy consumption requirement is minimal). Herein, wake up request, turn on request, and switch on WTRU assistance information may be used interchangeably. In one or more availability states (e.g., “micro sleep” or “deep sleep” states), a wake up request may be (e.g., exclusively) used. A wake-up request may refer to (e.g., be implemented by) a physical uplink signal transmitted by the WTRU to request a change of availability state. A wake-up request signal may be implemented based on a physical layer configuration. A switch-on request may (e.g., otherwise) be a physical layer indication or an L2 indication from the WTRU to the network. A switch-on request indication may be delivered as a MAC CE, UCI, radio resource control (RRC) signalling, a PUCCH, or a RACH indication. A switch-on request indication may include switch on WTRU assistance information and/or a positioning report.

A WTRU may determine an availability state (e.g., NES state) based on (e.g., a reception of) an availability state indication (e.g., from L1/L2 signaling (e.g., L1/L2 broadcast signaling), such as a group common DCI or indication). A WTRU may (e.g., implicitly) determine an availability state form the reception of periodic DL signalling (e.g., or lack thereof). A WTRU may determine whether a resource is available for transmission/reception and/or measurements for a determined network availability state, for example, based on whether the resource(s) is applicable in the active availability state.

An availability state may be applicable to at least one transmission, reception, and/or measurement resource. An availability state may be applicable to at least one time period, such as a time slot and/or a time symbol. An availability state may be applicable to a serving cell, a cell group, a frequency band, a bandwidth part (BWP), a TRP, a set of spatial elements, and/or a range of frequencies within a bandwidth part.

A WTRU may determine the active availability state associated with a cell, carrier, TRP, and/or frequency band to be “Off,” “Deep sleep,” or “Micro sleep,” for example, after reception of DL signaling that changes the cell's or TRP's availability state. For example, a WTRU may receive a turn off command on broadcast signaling (e.g., L1/L2 broadcast signaling), RRC signaling, DCI (e.g., a group common DCI), or a DL MAC CE. The WTRU may determine an availability state associated with a cell, carrier, TRP, and/or frequency band, for example, based on reception of an availability state indication (e.g., via L1/L2 signalling (e.g., L1/L2 broadcast signaling), such as a group common DCI or indication).

A WTRU may (e.g., implicitly) determine an availability state associated with a cell, carrier, TRP, and/or frequency band (e.g., “Off,” “deep sleep,” “micro sleep,” or “dormant”), for example, based on at least one of the following: reception of a command or signal indicating a change in availability state; reception of a paging message, a paging DCI, a paging PDSCH, and/or a paging related signal (e.g., paging early indication (PEI)), which may be based on a subset of paging occasions (POs) (e.g., those aligned with an NES discontinuous reception (DRX) cycle and/or a configured subset of PDCCH resources); a gNB DTX status (e.g., indicating whether the gNB is in active time or an associated activity timer is running); a lack of detection of a presence indication; a time (e.g., a time of day); the availability state of an associated cell (e.g., another carrier of the same MAC entity, another carrier in the same cell group, another carrier in the same gNB, another sector in the same gNB, and/or a configured associated cell or capacity boosting cell); detection of a PSS (e.g., PSS only) signal and/or an (e.g., a simplified/stripped down) SSB signal; a detection of an RS signal (e.g., CSI-RS, positioning reference signal (PRS), tracking reference signal (TRS) or the lack thereof; a WTRU's RRC state (e.g., Idle, inactive, or connected mode); whether paging has been received (e.g., within a configured time window); whether system information (e.g., periodic SI or a subset of SIBs) has been received (e.g., within a configured time window); and/or measured channel condition(s) being below (e.g., or above) a threshold.

A WTRU may (e.g., implicitly) determine an availability state associated with a cell, carrier, TRP, and/or frequency band (e.g., “Off,” “deep sleep,” “micro sleep,” or “dormant”), for example, based on reception of a command or signal indicating a change in availability state, such as a group common DCI in connected mode or signaling (e.g., RRC signaling), or a presence signal. A WTRU may (e.g., implicitly) determine an availability state, for example, based on the reception of periodic DL signaling. A WTRU may be configured or specified to associate an availability state with one or more DL signal types (e.g., SSB, partial SSB), and/or one or more periodicities.

A WTRU may (e.g., implicitly) determine an availability state associated with a cell, carrier, TRP, and/or frequency band (e.g., “Off,” “deep sleep,” “micro sleep,” or “dormant”), for example, based on (e.g., reception of) a paging message, a paging DCI, a paging PDSCH transmission, or a paging related signal (e.g., PEI), which may be based on a subset of POs (e.g., those aligned with an NES DRX cycle or a configured subset of PDCCH resources). A WTRU may determine (e.g., assume) an availability state, for example, based on (e.g., after the reception of) a paging message with a (e.g., certain) paging RNTI (P-RNTI), an (e.g., a separately configured) NES P-RNTI, and/or an NES group RNTI. A WTRU may determine (e.g., assume) a certain availability state, for example, based on a P-RNTI (e.g., after the reception of a paging message with a certain P-RNTI). A WTRU may be configured with one more PEI subgroups for NES. A subgroup may be associated with one or more availability states. A WTRU may determine (e.g., assume) a certain availability state based on (e.g., after reception of) a PEI with an NES subgroup, for example, if the subgroup is configured and/or associated with the availability state. The indication of the availability state and/or the availability state switch may be indicated in the paging payload, for example, as a flag part of the paging message and/or the short message. A paging indication may (e.g., further) indicate a (e.g., an alternate) cell to monitor paging on while the cell from which the signaling was received is off, asleep, or in an NES state. A paging indication may (e.g., further) indicate or signal (e.g., applicable) reconfiguration parameters (e.g., for initial access, applicable PRACH resources, applicable SSB/RS occasions, applicable SI cycle, and/or the applicable cell(s) and/or associated availability states).

A WTRU may (e.g., implicitly) determine an availability state associated with a cell, carrier, TRP, and/or frequency band (e.g., “Off,” “deep sleep,” “micro sleep,” or “dormant”), for example, based on lack of detection of a presence indication (e.g., determination that a presence indication was not received). For example, a WTRU may determine an availability state associated with the cell (e.g., “off” or “deep sleep”) if a presence indication was not detected on one or more presence indication occasion. For example, the WTRU may determine (e.g., assume) or change the cell's availability state based on (e.g., after a number of consecutive) misdetections and/or after a duration elapses (e.g., timer expires), for example, without detection of a presence signal. In some examples, a WTRU may determine an availability state is active or de-active after expiry of a timer associated with the availability state. A WTRU may (e.g., implicitly) determine an availability state, for example, based on a lack of reception of (e.g., periodic) DL signaling. For example, a WTRU may receive configuration information indicating (e.g., be configured with) a signal quality threshold (e.g., an RSRP threshold). The WTRU may determine that the availability state is not active and/or may determine a different availability state, for example, if the WTRU does not detect a signal associated with an availability state (e.g., a presence signal or an SSB) with a signal strength (e.g., at or) above the signal quality threshold. A criterion/condition may (e.g., also) be coupled with a lack of detection of an identifying sequence of the presence signal (e.g., detection of the PSS sequence).

A WTRU may (e.g., implicitly) determine an availability state associated with a cell, carrier, TRP, and/or frequency band (e.g., “Off,” “deep sleep,” “micro sleep,” or “dormant”), for example, based on time (e.g., time of day). For example, a WTRU may be configured to determine (e.g., automatically assume) a certain availability state (e.g., off, sleep, or dormant) for a configured subset of cells (e.g., capacity boosting cells) depending a time (e.g., a time of day). In some examples, a WTRU may determine that a capacity boosting cell has an availability state as “On” for a first configured time (e.g., hour(s) of the day), “Deep sleep” for a second configured time (e.g., hour(s) of the day), and/or “Off” for a third configured time (e.g., hour(s) of the day).

A WTRU may receive configuration information indicating (e.g., be configured) to monitor an indication that may characterize a level of network activity (e.g., an availability state). Network activity may be associated with a gNB and/or a cell. A WTRU may determine (e.g., assume) the same availability state for multiple (e.g., all) cells that are part of the same gNB, e.g., cells of the same MAC entity. A network activity indication (e.g., a presence indication) may include a channel (e.g., a PDCCH) and/or a signal (e.g., a sequence). An activity indication may indicate a level of activity the WTRU may expect from the associated gNB and/or cell, e.g., reduced activity. An activity indication may include activity information of other gNBs/cells. An activity indication may be a PDCCH with group common signaling. For example, a NW may transmit a group common DCI to a group of WTRUs (e.g., WTRUs in the serving cell) indicating a change of an activity state or activity level in UL and/or DL. The CRC of the PDCCH may be scrambled with a dedicated “activity indication RNTI.” A WTRU may receive configuration information indicating (e.g., be configured with) a (e.g., at least one) search space associated with the monitoring occasions of the activity indication PDCCH. The indication may include, for example, a go-to-sleep signal, e.g., a (pre) defined/(pre) configured sequence. A WTRU may expect a reduced activity level (e.g., over a specific/configured time duration), for example, if (e.g., when) the WTRU detects the sequence. A WTRU may activate connected mode DRX (C-DRX) for an indicated/configured period of time. In some examples, multiple (e.g., two) sequences may be used to indicate regular activity and reduced activity.

Signaling within a PDCCH or an activity indication may include, for example, at least one of the following: an expected activity level of the associated gNBs/cells over a time interval (e.g., an availability state); transmission and/or reception attributes for a (e.g., each) activity level (e.g., availability state); one or more (e.g., a set of) configurations that may be used/applied for associated/indicated activity level(s); a time interval over which an activity level is assumed (e.g., as may be signaled in the PDCCH or part of the activity indication); and/or a (pre) determined/(preconfigured time interval over which an activity level is determined (e.g., assumed).

Signaling within a PDCCH and/or an activity indication may include an expected activity level of the associated gNBs/cells over a time interval (e.g., an availability state). Activity levels may be predetermined and/or configured. Activity levels may include regular and reduced activity. The signaling may indicate the activity level. For example, bit “1” may indicate regular activity and bit “0” may indicate reduced activity.

Signaling within a PDCCH and/or an activity indication may include transmission and reception attributes for an (e.g., each) activity level (e.g., availability state). For example, a WTRU may (e.g., during reduced activity) not (e.g., be expected to) monitor certain PDCCH search spaces (e.g., including all SSs), receive a certain type of PDSCH (e.g., including all PDSCH), transmit PUCCH/PUSCH, and/or perform certain measurements.

Signaling within a PDCCH and/or an activity indication may include configuration information (e.g., one or more (e.g., a set of) configurations) associated with an activity level that may be used/applied if (e.g., when) the activity level is indicated. Configuration information associated with activity levels may indicate, for example, SS configurations, CSI reporting configurations, indices of transmitted SSBs, etc. A (e.g., each) set of configurations may have an attribute associated with an activity level. An attribute associated with an activity level may include, for example, a tag that can be set to “reduced activity.”

Signaling within a PDCCH and/or an activity indication may include a time interval over which an activity level is determined/assumed. A time interval may be indicated, for example, using a bitmap. A (e.g., each) bit in the bitmap may be associated with a specific duration, e.g., a slot or a frame. For example, bit “1” may indicate regular activity and bit “0” may indicate reduced activity on an associated frame. A time interval may be indicated with a start time and/or an interval length. A start time may be determined; for example, by adding an (e.g., a fixed) offset to the time the indication is received. The length of the interval may be configured or signaled in the indication PDCCH transmission.

A WTRU may receive configuration information indicating (e.g., be configured or predefined with) a (e.g., alternate) serving cell to perform initial access, mobility, or cell reselection, for example, in the event a current serving cell or a capacity boosting cell is turned off and/or if a certain (e.g., configured, indicated, specified) condition is met. A WTRU may be configured (e.g., per broadcast signaling or dedicated signaling) with a list of fallback or alternate serving cells (e.g., per serving cell or per gNB). For example, a WTRU may initiate a cell reselection and/or mobility procedure to an alternate serving cell associated with a cell or gNB from which a turn-off indication was received. In some examples, a turn off or go-to-sleep indication may (e.g., dynamically) indicate to the WTRU which cell to fallback or connect to. An indication may be provided, for example, by dedicated or broadcast signaling. A fallback/alternate cell may be (pre) configured or (pre) defined to be a cell within the same gNB from which a sector has entered an NES state (e.g., off, sleep, or reduced power). A fallback cell may be (pre) configured/(pre) defined as a master node cell, for example, if a WTRU is in dual connectivity. A fallback/alternate cell may be (pre) configured or (pre) defined to be a cell associated with a different RAT or frequency band. For example, a WTRU may fall back to an LTE or an FR1 cell associated with the cell or gNB from which the turn off indication was received (e.g., if the WTRU is in carrier aggregation (CA) or dual connectivity (DC) using multiple RATs or multiple frequency bands).

A WTRU may determine that an uplink or downlink resource and/or signal are available for transmission/reception and/or measurements for the determined network availability state, for example, if applicable in the active availability state. A WTRU may determine that one or more (e.g., a subset of) measurement resources and/or signals (e.g., SSBs, CSI-RS, TRS, PRS) are not applicable in one or more (e.g., certain) availability states. A WTRU may determine that one or more (e.g., a subset of) uplink or downlink resources (e.g., PRACH, PUSCH, PUCCH) are not applicable in certain availability states. A WTRU may transmit one or more (e.g., some) uplink signals, for example, (e.g., only) in a subset of NW availability states (e.g., sounding reference signal (SRS), positioning reference signals (pRS) (e.g., positioning sounding reference signal (pSRS), PRACH, UCI).

NES WTRU groups may be provided. WTRUs may be grouped for the purpose of NES, for example, to (e.g., simultaneously) control a number of WTRUs, e.g., to indicate a BWP switch, to indicate a change of NW availability state, to indicate a change to WTRU DRX cycles/parameters, for mobility/cell re-selection, paging, and/or activation/deactivation of DL measurement resources. A WTRU may be configured with an NES group RNTI (e.g., an NES group identifier), which may be used to signal one or more WTRUs in a (e.g., the same) serving cell. A WTRU may monitor a cell specific DL resource for reception of control and/or data, and/or to receive group common indications for NES (e.g., group common DCI, an availability state switch command, or an NES PCell switch command).

A cell presence indication may be provided. A WTRU may monitor for reception of a presence indication or signal associated with a gNB configured with one or more availability states (e.g., on, off, dormant, and/or deep sleep). A presence indication may be a physical downlink signal transmitted by the associated cell or gNB that is sleeping, e.g., in certain availability states, such as deep sleep, micro sleep, dormant, or off. A presence indication may (e.g., alternatively) be downlink information (e.g., downlink information bits) that are delivered to the WTRU, for example, by broadcast signalling (e.g., system information block (SIB) or by dedicated signalling (e.g., RRC signalling or MAC CE).

A WTRU may change to an availability state based on/associated with (e.g., detection of) a presence signal (e.g., WTRU assume “On”). For example, a WTRU may (e.g., successfully) receive a response from a requested cell. A response may be provided to transmitted WTRU assistance information or a switch-on request. A response may be the reception of a DL signal or channel (e.g., SSB(s), CSI-RS, PRS, PDCCH, DCI, PDSCH, HARQ-ACK) or an L2 message (e.g., an RRC message, DL MAC CE, Msg2, MsgB, or Msg4). A WTRU may monitor (e.g., start monitoring) additional TRPs, SSBs and/or CSI-RS resources, for example, after the transmission of the wake-up WTRU assistance information or the switch-on request or successful reception of a response. A WTRU may change to an availability state associated with detecting a presence signal (e.g., On), for example, after the WTRU (e.g., successfully) measures channel conditions (e.g., RSRP, SINR) on measurement resources of the associated cell above a configured threshold.

A presence indication signal may be, for example, at least one of the following: a simplified or stripped down SSB signal, e.g., PSS/SSS without PBCH multiplexed, a wide beam or omni-directional SSB, a PRS, a CSI-RS, a signal detected based on energy sensing (e.g., a DL signal associated with a wake-up radio, for example, if the WTRU is equipped with a capability to detect the DL signal), a PDSCH or PDCCH received on a different cell or TRP (e.g., on a configured subset of resources), CORESETs, or search spaces, and/or one or more SSBs received on a different cell or TRP (e.g., configured on a subset of SSB occasions).

Conditional handover (HO) and conditional primary secondary (PSCell) change (CPC) in a network may be provided. A conditional handover (CHO) and a conditional PSCell addition (CPA)/conditional PSCell change (CPC) may reduce the likelihood of radio link failures (RLF) and/or handover failures (HOF). CPA/CPC may be collectively referred to as CPAC.

A handover (e.g., legacy LTE/NR handover) may be triggered by measurement reports. A network may send an HO command to a WTRU without receiving a measurement report. For example, a WTRU may be configured with an A3 event that triggers a measurement report to be sent if (e.g., when) the radio signal level/quality (e.g., RSRP, RSRQ, etc.) of a neighbor cell becomes better than the Primary serving cell (PCell) or also the Primary Secondary serving Cell (PSCell), e.g., in the case of dual connectivity (DC). A WTRU may monitor a serving cell and neighbor cells. A WTRU may send a measurement report, for example, if (e.g., when) the conditions are fulfilled. A network (e.g., a current serving node/cell) may (e.g., if (e.g., when) a report is received) prepare an HO command (e.g., an RRC reconfiguration message, such as with a reconfigurationWithSync). The network may send the HO command to the WTRU. The WTRU may (e.g., immediately) execute the HO command, which may result in the WTRU connecting to the target cell.

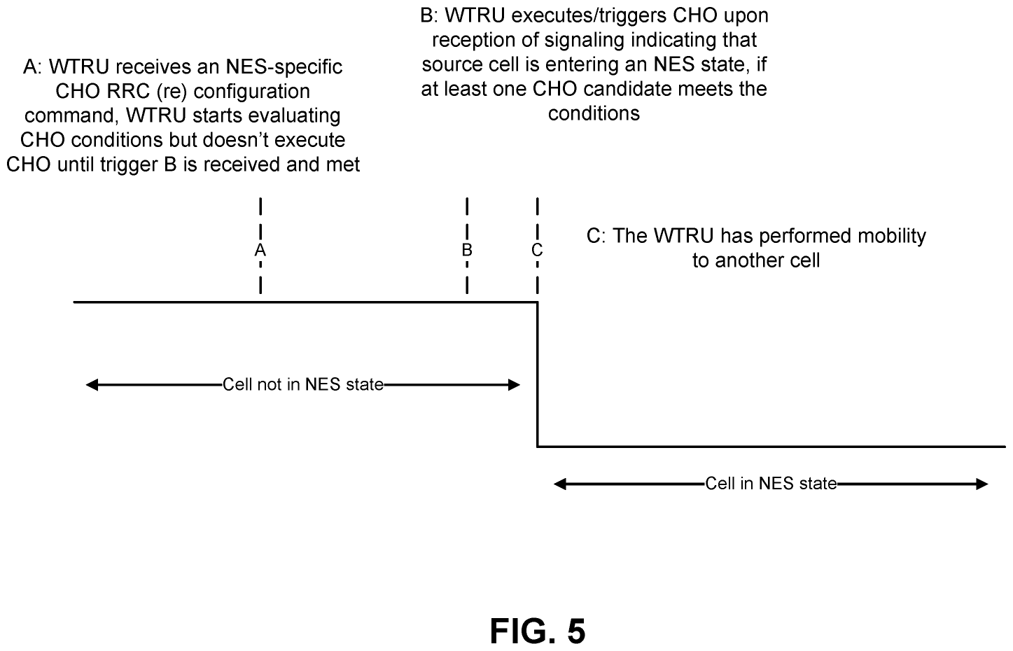

A CHO may differ from other handovers (e.g., legacy handovers). For example, multiple handover targets may be prepared for a CHO (e.g., as compared to one target for another type of handover). A WTRU may refrain from (e.g., immediately) executing a CHO (e.g., as compared to immediate execution of another type of handover), for example, until a CHO condition is satisfied (e.g., WTRU may evaluate CHO conditions but refrain from executing CHO until a trigger is received/met (e.g., source cell is entering an NES state) as shown in FIG. 5). A WTRU may receive configuration information (e.g., be configured) with triggering conditions for a CHO (e.g., NES-specific handover conditions), for example, such as a set of radio conditions. A WTRU may execute a conditional handover towards one of the targets, for example, if (e.g., when) the triggering condition(s) is fulfilled.

A CHO command may be sent, for example, if (e.g., when) the radio conditions towards current serving cells are still favorable, thereby reducing a likelihood of failure in handover, e.g., failing to send a measurement report, such as if (e.g., when) the link quality to the current serving cell falls below a threshold (e.g., acceptable levels) if (e.g., when) the measurement reports are triggered for a handover, and/or failure to receive a handover command, such as if (e.g., when) the link quality to the current serving cell falls below a threshold (e.g., acceptable levels) after the WTRU sent the measurement report, but before the WTRU receives an HO command.

Triggering conditions for a CHO may (e.g., additionally and/or alternatively) be based on the radio quality of the serving cells and/or neighbor cells (e.g., conditions that may be used to trigger measurement reports). For example, a WTRU could be configured with a CHO that has A3-like triggering conditions and an associated HO command. The WTRU may monitor current and/or serving cells. The WTRU may execute an associated HO command and switch a connection towards a target cell (e.g., instead of sending a measurement report), for example, if (e.g., when) the A3 triggering conditions are fulfilled.

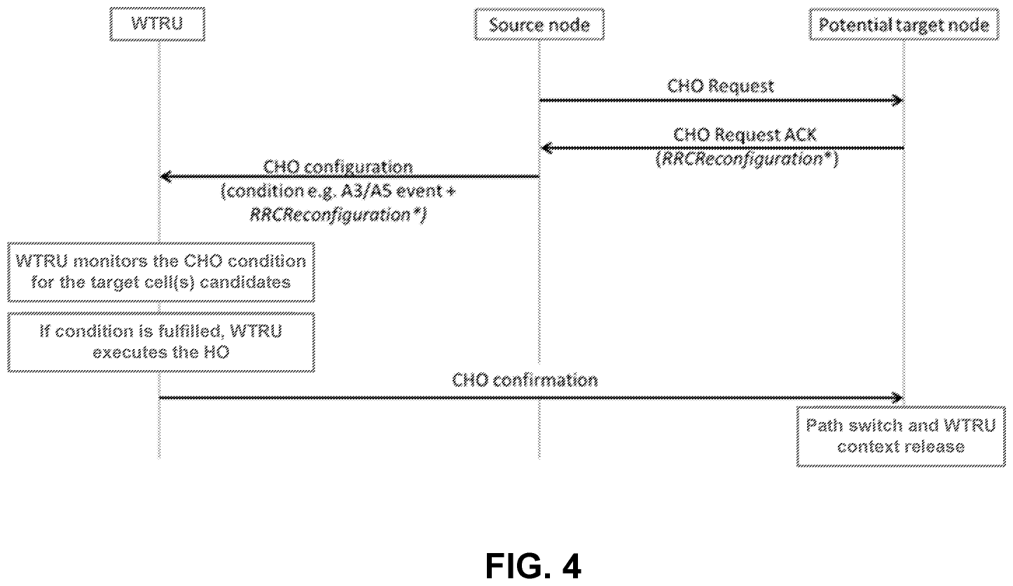

FIG. 4 illustrates an example of a conditional handover configuration and execution.

FIG. 5 illustrates an example of NES-specific CHO and execution.

A CHO may help prevent unnecessary re-establishments in case of a radio link failure (RLF). For example, a WTRU may receive configuration indication indicating (e.g., be configured with) multiple CHO targets (e.g., handover candidates). The WTRU may experience an RLF before the triggering conditions with any of the targets gets fulfilled. In some examples (e.g., legacy operation), an RRC re-establishment procedure may be implemented, which may incur considerable interruption time for the bearers of the WTRU. In some examples, a WTRU may, e.g., after detecting an RLF, end up a cell for which the WTRU has an associated CHO (e.g., the target cell is prepared for a handover). The WTRU may execute the HO command associated with the target cell, for example, instead of continuing with a full re-establishment procedure.

CPC and CPA are extensions of CHO, e.g., in DC scenarios. A WTRU may receive configuration information indicating (e.g., be configured with) a triggering condition(s) for a PSCell change or addition. A WTRU may execute the associated PSCell change or PSCell add commands, for example, if (e.g., when) the triggering conditions are fulfilled.

Measurement and event configuration information for handover and conditional handover may be provided. Measurement configuration information provided to a WTRU may include, for example, one or more of the following: one or more measurement objects; one or more reporting configurations; one or more measurement ID configurations; an S-measure configuration; a quantity configuration; and/or a measurement gap configuration.

A measurement object may specify what a WTRU may measure and/or information regarding how a measurement may be performed. Information may include, for example, one or more of the following: the RAT, frequency, sub carrier spacing, SSB periodicity/offset/duration, reference signals and/or signal types to be measured, a list of allowed/excluded neighbor cells of the concerned RAT/frequency to be measured, measurement gaps, offset that may be applied to prioritize/de-prioritize certain cells, etc.

A WTRU may receive configuration information indicating (e.g., be configured with) multiple measurement objects. A WTRU may have measurement configurations related to different frequencies and/or a different RAT. A WTRU may receive configuration information (e.g., be configured with) a (e.g., up to 64) measurement object(s). A (e.g., each) measurement object may be identified by a measurement object ID.

Reporting configuration information may specify (e.g., indicate) what is to be reported (e.g., reference signal type, such as CSI-RS or SSB, the beam and/or cell level quantities to be reported, such as RSRP/RSRQ, a maximum number of cells and/or beams to be reported, etc.). Reporting configuration information may specify reporting criteria. A WTRU may send a measurement report or execute an associated HO configuration (e.g., in the case of CHO), for example, if (e.g., when) criteria are fulfilled. Reporting criteria may be, for example, the expiry of a periodic timer (e.g., a periodic reporting configuration) and/or based on one or more radio conditions of serving and/or neighbor cells. A WTRU can be configured with (e.g., up to 64) reporting configurations. A (e.g., each) reporting configuration may be identified by a reporting configuration ID.

A measurement object may be associated with one or more reporting configurations. An association may be made through a measurement ID. A measurement ID configuration may be, for example, a list of one or more of the following: a measurement ID; a measurement object ID; and/or a reporting configuration ID.

A WTRU may be configured with (e.g., up to 64) measurement IDs. Event triggered reporting may be configured, for example, based on one or more of the following events: event A1 (e.g., serving cell (e.g., measurement) becomes greater (e.g., better) than threshold); event A2 (e.g., serving cell (e.g., measurement) becomes less (e.g., worse) than threshold); event A3 (e.g., neighbor cell (e.g., measurement) becomes an offset greater (e.g., better) than SpCell (e.g., source cell measurement)); event A4 (e.g., neighbor cell (e.g., measurement) becomes greater (e.g., better) than threshold); event A5 (e.g., SpCell (e.g., source cell measurement) becomes less (e.g., worse) than a first threshold (e.g., threshold1) and neighbor cell (e.g., measurement) becomes greater (e.g., better) than a second threshold (e.g., threshold2); event A6 (e.g., neighbor cell (e.g., neighbor cell measurement) becomes an offset greater than (e.g., better) than SCell (e.g., source cell measurement)); event B1 (e.g., inter RAT neighbor cell (e.g., measurement) becomes greater (e.g., better) than a threshold); and/or event B2 (e.g., PCell (e.g., source cell measurement) becomes less than (e.g., worse) than a first threshold (e.g., threshold1) and inter RAT neighbor cell (e.g., measurement) becomes greater than (e.g., better) than a second threshold (e.g.,threshold2).

The term SpCell refers to a primary cell (PCell) or a primary secondary Cell (PSCell) (e.g., in the case of DC). Event A3, A5, B2 may (e.g., only) be configured for the PCell or PSCell. Events A1, A2, A3, A5, B2 may be configured for any serving cell. Event A6 may be configured (e.g., only) for SCells (e.g., for the secondary cells in carrier aggregation (CA)). Events A4 and B1 may be related to neighbor cell measurements (e.g., not related to any serving cell).

An (e.g., each) event configuration may be associated with a threshold (e.g., an offset), hysteresis, and/or timeToTrigger (TTT) parameters.

A WTRU may perform an HO (e.g., execute an HO command) in the case of CHO (e.g., instead of sending a measurement report), for example, if (e.g., when) reporting conditions are fulfilled. A CHO may be implemented, for example, based on one or more of the following event triggered reporting configurations: CondEvent A3 (e.g., neighbor cell (e.g., measurement) becomes an offset greater (e.g., better) than a source cell (e.g., SpCell measurement)); CondEvent A4 (e.g., neighbor cell (e.g., measurement) becomes greater (e.g., better) than a threshold); and/or CondEvent A5 (e.g., SpCell (e.g., source cell measurement) becomes less than (e.g., worse) than a first (e.g., threshold1) and a neighbor cell (e.g., measurement) becomes greater than (e.g., better) than a second threshold (e.g., threshold2).

CHO configuration information may include, for example, one or more of the following: a conditional reconfiguration ID; a conditional reconfiguration triggering condition; and/or an RRC reconfiguration, which may be executed if (e.g., when) the conditions are fulfilled (e.g., HO command).

Triggering conditions may refer to one or more (e.g., two) measurement IDs. Multiple (e.g., two) measurement IDs may be specified. Multiple measurement IDs may refer to the same measurement object (e.g., one measID associating the measurement object related to the PCell with an A3 event and another measID associating the same measurement object with an A5 event).

In some examples, a WTRU may receive configuration information indicating (e.g., be configured with) a maximum number of (e.g., eight (8)) CHO configurations.

Network energy consumption may be significant and, in some cases, unnecessary, e.g., during quiet hours. A network may, for example, (e.g., determine to) turn off small cells and rely on macro-cells for coverage during quiet hours, turn off one or more (e.g., some) sectors or gNBs, reduce power amplifier (PA) power consumption, and/or enable a gNB-side sleep pattern, e.g., without significantly/considerably sacrificing WTRU performance. In some examples, gNBs may combine information, such as WTRU measurements, WTRU assistance information, interference status, load information, proprietary information, and/or the like, to make a determination/decision about energy conservation.

A WTRU may experience a coverage loss, for example, if (e.g., when) one or more (e.g., some) cells activate NES and the WTRU (e.g., in IDLE or INACTIVE state) is not aware that a gNB is in an NES state (e.g., deep sleep or dormant). Network availability resources may be adapted to assist a WTRU with distinguishing whether common cell signals (e.g., SSBs, paging, SI) are transmitted (e.g., as usual) or whether cell signals are not being received due to bad channel conditions.

One or more WTRU control-plane procedures for connectivity management, WTRU reachability, cell re-selection, and/or WTRU battery consumption may be impacted, for example, if (e.g., when) gNBs sleep or turn off, including one or more of the following issues: inter-cell mobility and/or intra-cell mobility/TRP muting.

In an example of inter-cell Mobility, a network may determine to offload/handover remaining connected WTRUs to other cells in the area if (e.g., when) a gNB turns off or goes to dormant or deep sleep state. Executing handover commands/RRC reconfiguration for (e.g., each of) the remaining WTRUs may involve signaling, which may delay the time the gNB goes to sleep. A gNB may use a conditional handover (CHO) to reduce an HO signaling load. The WTRU may trigger the mobility, for example, by configuring one or more candidate cells for a handover if (e.g., when) CHO condition(s) are met (e.g., signal level of serving/neighbor cell meets an absolute/relative threshold). Reliance on conditional handover conditions, such as RSRP, may impact load distribution, such as if (e.g., when) a large number of WTRUs suddenly migrate to the same cell, which may create a RACH storm. Mobility to other gNBs may (e.g., also) involve re-acquisition of security keys.

A WTRU may (e.g., also) be unaware of which SSBs/RACH occasions to use for an RA initiated at the target cell. Transmitting a preamble to a target cell that is sleeping may prolong a handover procedure or may cause the handover procedure to prematurely fail (e.g., due to expiry of the T304 timer).

Configuring CHO for a multitude of WTRUs may consume significant resources at the network, for example, unless the CHO is executed within a short period of time.

In an example of intra-cell mobility/TRP muting, TRP on/off for a cell with multi-TRP may be enabled if (e.g., when) a TRP is muted. Remaining connected WTRUs served by the TRP may stop monitoring PDCCH with the associated TCI state and CSI-RS associated with the TRP, for example, to avoid a beam failure detection for the TRP despite not having beams transmitted.

The terms “energy saving mode,” “power saving mode,” and “sleep mode” may be used interchangeably.

Measurement reporting, cell reselection, and mobility may be provided in NES. A WTRU may obtain/receive information (e.g., an indication) about a current or upcoming change of an NES state of a serving cell and/or a neighbor cell (e.g., an indication the indicates that the source cell is entering an NES state).

In some examples, detection of a serving cell's transition to a power saving mode (e.g., an NES state, e.g., the serving cell being turned off) may be performed by the WTRU by reading broadcasted system information on the serving cell. System information (SI) may include timing information (e.g., relative time or absolute time information), which may indicate when the serving cell will be turned off and/or start to operate in power saving mode (e.g., the information may indicate a time that the source cell is entering (e.g., will enter) an NES state).

In some examples, the detection of a neighbor cell's transition to a power saving mode (e.g., an NES state, such as the serving cell being turned off) may be performed by a WTRU by reading broadcasted system information on the neighbor cell. System information may include timing information (e.g., relative time or absolute time information), which may indicate when the neighbor cell will be turned off and/or start to operate in power saving mode.

In some examples, the detection of a neighbor cell's transition to a power saving mode (e.g., an NES state, such as the serving cell being turned off) may be performed by the WTRU by reading broadcasted system information on the serving cell. System information may include timing information (e.g., relative time or absolute time information), which may indicate when the neighbor cell will be turned off and/or start to operate in power saving mode.

In some examples, a WTRU may be provided with dedicated information (e.g., in an RRC message, a MAC CE, etc.). The information may indicate when the serving cell or/and a neighbor cell will transition to a power saving mode, an availability state, and/or will be turned off. For example, the information may indicate an absolute time, a relative delta time from the reception of the information, etc.

In some examples, a WTRU may be provided with shared/group information (e.g., in a DCI scrambled with a WTRU group identity). The information may indicate when the serving cell and/or a neighbor cell will transition to a power saving mode, an availability state, and/or will be turned off. For example, the information may indicate an absolute time, a relative delta time from the reception of the information, etc. Different DCIs may be specified for different NES states.

Measurement reports may be triggered by current or upcoming changes in an NES state of a serving cell and/or a neighbor cell. In some examples, a WTRU may be configured to send a measurement report to the network based on (e.g., upon) detecting that the NES state of a serving cell and/or a neighbor cell has changed or is expected to be changed (e.g., transitioning into a power saving mode, being turned off, transitioning into non-power saving mode, etc.).

A WTRU may perform a conditional/group handover, for example, based on information about a current or upcoming change of an NES state of a serving cell and/or a neighbor cell.

In some examples, a WTRU may execute a (pre) configured HO (e.g., CHO) towards a target cell based on (e.g., upon) detecting that the current serving cell is being turned off or transitioning to a power saving mode (e.g., a different availability state, such as an NES state). A detection may include, for example, receiving an availability state switch command (e.g., indication) and/or determining the cell is in a given availability state (e.g., determining that the cell is entering an NES state). Executing an HO based on a condition (e.g., a detection or determination) may be considered a CHO with a triggering condition based on the power saving mode or availability state of the current serving cell (e.g., the WTRU may refrain from performing a CHO (e.g., if a triggering condition is satisfied) until a determination that the cell (e.g., source cell) is entering an NES state).

In some examples, a WTRU may execute a pre-configured HO upon detecting that a neighbor cell is being turned on or transitioning to a fully operational state (e.g., from a power saving mode or a different availability state). Executing an HO based on a condition (e.g., a detection or determination) may be considered a CHO with a triggering condition based on the power saving mode or availability state of the target cell.

In some examples, a CHO that considers the serving and/or neighbor cell's energy saving state may be (e.g., further) constrained by the current serving cell and/or target cell signal levels. For example, a WTRU may be configured with one or more of the following triggers for a CHO: (a) RSRP_target>RSRP_serving+threshold 1, e.g., if (e.g., when) both cells are in normal operating mode; (b) RSRP_target>RSRP_serving+threshold 2, e.g., if (e.g., when) the serving cell is in power saving mode and the target is in normal operating mode; (c) RSRP_target>RSRP_serving+threshold 3, e.g., if (e.g., when) the serving cell is in normal mode and the target is in power saving mode; (d) RSRP_target>RSRP_serving+threshold 4, e.g., if (e.g., when) both cells are in power saving mode; (e) RSRP_target>threshold_5, e.g., if (e.g., when) serving cell is not detected any more (turned off suddenly) and target in normal mode; and/or (f) RSRP_target>threshold_6, e.g., if (e.g., when) serving cell is not detected any more (turned off suddenly) and target in power saving mode.

In some examples (e.g., trigger (b), threshold_2 may be negative (e.g., the WTRU may be offloaded to the target even if the radio conditions to the source are better).

In some examples, threshold_3 may be greater than threshold_1, e.g., to ensure that the WTRU is handed over to a power saving target cell (e.g., only) if the conditions in the target cell are considerably better than the source cell.

In some examples, threshold_4 may be equal to or different from threshold_1.

CHO configuration information may be provided to a WTRU in one CHO configuration, or multiple (e.g., independent) CHO configurations. In some examples, a WTRU may select a CHO configuration to monitor from among multiple configurations. A selection may be based on the operating mode of the source and/or target.

In some examples, a target cell in a CHO configuration may include a list of target cells (e.g., a list of cells that belong to the same gNB as the current serving cell, for example, handover candidates).

In some examples, a WTRU (e.g., or a group of WTRUs) may receive configuration information indicating (e.g., be configured) to perform an HO (e.g., a group HO). An HO or group HO may be performed before the serving cell of the WTRU or the group of WTRUs is turned off (e.g., or put into power saving mode). An HO or group HO may be triggered, for example, by L1/L2/L3 signaling (e.g., DCI, MAC CE, RRC), broadcast signaling, etc. WTRUs may be configured (e.g., for a group HO) with a group identity. The group HO signaling maybe associated with the group identity (e.g., a DCI scrambled with the group identity).

In some examples, a WTRU may (e.g., upon performing the handover) reuse (e.g., all) the configuration regarding the old SpCell. The reused configuration may be substituted for the new SpPCell (e.g., without explicit RRC reconfiguration for the CHO configuration).

In some examples, a WTRU may be configured to perform an HO (e.g., only) if the target SpCell belongs to the same gNB/DU that is also controlling source SpCell. The trigger information may be implicit (e.g., determined by reading system information of the target cell), explicit (e.g., WTRU configured with a list of cells, such as a list of physical cell identities (PCIs), that belong to the same gNB), or specified as a rule.

In some examples, a WTRU may (e.g., upon performing the HO) update (e.g., implicitly update) the KgNB and/or the integrity protection and encryption keys for the UP and/or CP based on the new SpCell's PCI, frequency, etc. (e.g., without explicit signaling to update security keys).

In some examples, a WTRU may be configured with fallback or alternate cells (e.g., a list of PCIs) in case the current serving cell suddenly transitions to a power saving mode, is turned off, or moves into a different/specific availability state (e.g., sleep, dormant, or off). A list of fallback alternate cells may be provided to the WTRU by dedicated information (e.g., in RRC message), broadcasted information (e.g., SIB information at the current serving cell some time before the current serving cell is switched off, etc.). In some examples, a WTRU may be unable to detect a current serving cell (e.g., after current serving cell is turned off) or the WTRU may detect that the current serving cell starts operating at a power saving mode/NES state that may not be suitable for the WTRU, e.g., based on current WTRU conditions, such as configured bearers, UL/DL data rate, or measured channel conditions/coverage. The WTRU may search for (e.g., try to find) one or more of the indicated fallback alternate cells and attempt to perform an HO towards one of them (e.g., to the best cell amongst the fallback cells, such as a cell that may fulfill a certain minimum signal level threshold). The WTRU may (e.g., when performing an HO) apply HO operations described herein (e.g., derive the KgNB and associated UP/CP security keys, use the old SpCell configuration for the new cell, etc.). Each fallback cell may or may not involve a specific RRC reconfiguration. In some examples, the network may preconfigure a CHO-like configuration for one or more (e.g., all or a subset) of the fallback cells (e.g., cells that belong to another gNB).

In some examples, the (e.g., legacy) behavior of re-establishment upon not detecting the current serving cell (e.g., on RLF) may be modified. For example, a serving cell may be capable of operating in power saving mode or may be turned off. A WTRU may, e.g., based on not being able to detect the current serving cell, explore other fallback mechanisms before resorting to re-establishment. For example, before resorting to re-establishment, the WTRU may try to connect/HO to fallback cells, execute a (e.g., any) CHO configuration, try to connect/HO to cells of the same gNB that the WTRU can detect as having good signal levels, etc.

A sudden change of the operating mode of the serving cell (e.g., power saving mode, a change in the availability state, cell turned off, etc.), may cause a multitude of WTRUs that are being served by the cell to perform a handover (e.g., almost simultaneously) to neighbor cell(s), which may cause problems (e.g., a lack of RACH resources for initial access at the new cell). In some examples, the handover of WTRUs reacting to the sudden change may be prioritized over WTRUs that are performing normal HO/CHO (e.g., source and target are operating in normal mode).

In some examples, a set of (e.g., dedicated) RACH resources may be allocated to WTRUs that are being handed over to a target cell. For example, the set of resources may not be used by WTRUs coming from source cells that are in normal operating mode.

In some examples, WTRUs in a cell that is being turned off or switching to a power saving mode/NES state may perform a gradual handover (e.g., from a time perspective). For example, a WTRU may detect that the power saving mode is turned on, or detect that the cell is to be switched off soon or is about to transition into a different availability state. The WTRU may (e.g., based on the detection/determination), perform one or more of the associated HO procedures described herein (e.g., after a delay). For example, a WTRU may detect that the current cell is to be switched off or is transitioning into an NES state within a time (t1). The WTRU may (e.g., randomly) select a time between 0 and t1 (e.g., from a uniform random distribution), and initiate the handover at the selected time. The value of t1 may be configured or predetermined. Random selection of HO initiation times may reduce the likelihood that all (e.g., similarly situated) WTRUs will try to access the RACH resources at the target cell at the same time, e.g., even if a contention-based RACH procedure is to be applied for initial access.

In some examples, the WTRUs may apply a RACH-less HO towards the target cell based on determining that (e.g., upon detecting) the source cell is to be turned off or to switch to using a power saving mode/NES state (e.g., if the source and target cell belong to the same gNB).

A WTRU may perform cell re-selection, for example, based on information about a current or upcoming change of NES state of a serving and/or neighbor cell.

In some examples, a WTRU in IDLE or INACTIVE state (e.g., an IDLE/INACTIVE WTRU) may be configured to not to perform cell re-selection to a cell that is operating in power saving mode or an NES state.

In some examples, an IDLE/INACTIVE WTRU may receive configuration information indicating to (e.g., be configured to) apply a (e.g., certain, selected, (pre)configured) negative offset to the signal level of a neighboring cell that may be operating in power saving mode.

In some examples, an IDLE/INACTIVE WTRU may receive configuration information indicating to (e.g., be configured to) apply a (e.g., certain, selected, (pre) configured) positive offset to the signal level of a neighboring cell if the WTRU detects the current serving cell has started to operate in a power saving mode.

In some examples, an INACTIVE WTRU may receive configuration information indicating to (e.g., be configured to) apply a negative or positive offset to the signal level of a neighboring cell (e.g., as described herein) depending on the saved WTRU context. A WTRU may apply one or more offsets during cell re-selection measurements/evaluations, e.g., so that cells that are operating in normal mode may be prioritized, for example, if the WTRU has bearers configured that require high data rate and/or high latency.

Mobility may be triggered by coverage loss in NES.

A WTRU may use and/or be configured with alternative threshold(s) for mobility, which may be used, for example, if the source and/or target cell is determined to be in one or more availability state(s), e.g., an alternative value for A3 or A5 events. A WTRU may apply a (pre) configured or (pre) determined offset to default mobility thresholds (e.g., an offset added or subtracted from already configured A3 or A5 event thresholds in the default state), for example, if the source and/or target cell is determined to be in one or more availability state(s), an NES state, or a reduced power state.

In some examples, a WTRU may (e.g., then) apply or use the alternative mobility thresholds and/or apply a mobility threshold offset for NES and/or initiate a mobility procedure based on (e.g., upon) determining that the source cell is in a PA power efficient state or an NES state. A WTRU may determine that the serving/source cell is in a reduced power state or an NES state, for example, based on at least one of the following ways.

A WTRU may determine that the serving/source cell is in a reduced power state or an NES state, for example, by determining that the DL power is reduced for one or more downlink channels and/or signals (e.g., SSB, RS, or CSI-RS).

A WTRU may determine that the serving/source cell is in (e.g., is entering) a reduced power state or an NES state, for example, based on reception of signaling or an indication from the NW (e.g., as shown in FIG. 5), which may include receiving an indication from the network about power reduction, receiving an indication from the network about an availability state change associated with the source or target cell, and/or receiving or detecting an SSB associated NES (e.g., a stripped down SSB, a PSS-only SSB).

A WTRU may determine that the serving/source cell is in a reduced power state or an NES state, for example, based on a determination/indication that the availability state has changed for the source or target cell, and/or based on measured channel conditions (e.g., L1 or L3 RSRP) of the source cell below a threshold.

A WTRU may determine that the serving/source cell is in a reduced power state or an NES state, for example, based on channel measurements. For example, a WTRU may measure channel conditions (e.g., L1 or L3 RSRP) of the target cell above a threshold, and/or a WTRU may measure the change in the channel conditions (e.g., L1 or L3 RSRP) of the source cell to be larger than a threshold (e.g., the WTRU may determine that the source cell is entering an NES state based on a determination that a change between a first measurement and a second measurement associated with the source cell exceeds a threshold). The WTRU may receive configuration information (e.g., be (pre) configured with) or may (pre) determine a period to determine the change in measured values.

A WTRU may determine that the serving/source cell is in a reduced power state or an NES state, for example, based on a determination that a TRP in the source/serving cell is muted for NES.

A WTRU may determine that the serving/source cell is in a reduced power state or an NES state, for example, based on detection of a change in measured channel conditions associated with a spatial element larger than a threshold (e.g., L1 RSRP of a CSI resource associated with a TRP).

A WTRU may determine that the serving/source cell is in a reduced power state or an NES state, for example, based on a determination that the serving cell's PA is operating in a non-linear state.

A WTRU may measure (e.g., start measuring) SSBs and/or RSs associated with a target cell based on (e.g., upon) detection of one or more events described herein (e.g., SSBs or CSI-RS configured for mobility) and/or evaluate configured CHO conditions. A WTRU may measure (e.g., start measuring) SSBs and/or RSs associated with a different TRP in the same cell based on (e.g., upon) detection of one or more events described herein (e.g., SSBs or CSI-RS configured for a different TRP). A WTRU may add one or more triggers (e.g., as described herein) to execute a conditional handover on any of the configured candidates.

A WTRU may track a time (e.g., start a timer) based on (e.g., upon) detection of any of one or more events (e.g., a mobility timer, T304, a timer similar to T304, or an NES cell validity timer). In examples, a timer may be an existing T304 timer or a new timer. A WTRU may start tracking a time (e.g., via a timer) based on (e.g., upon) performing HO, initiating an RA for HO at the target cell, and/or evaluating (e.g., starting to evaluate) CHO conditions at a candidate cell. A WTRU may scale the duration (e.g., value configured for T304 or use an alternative configured NES value for a timer), for example, if the cell is in an NES state, e.g., based on/upon starting to track the time (e.g., via the timer). A WTRU may initiate an RLF procedure, an SCG failure procedure, revert to connect to the source cell, and/or transmit an NES wake-up request, for example, based on (e.g., upon) a duration elapsing (e.g., expiry of a timer).

A WTRU may receive an indication on the (e.g., exact) time of (e.g., or time period until) power reduction at the serving cell. The WTRU may determine (e.g., may be configured to assume) a reduced power NES state, and/or a different availability state is applicable after a time period elapses since/after receiving an indication (e.g., from the gNB) about an availability state change and/or a power reduction state. A WTRU may (e.g., periodically) determine the power of the serving cell (e.g., or the coverage level determined from cell measurements) from semi-static configurations. For example, a WTRU may (e.g., be configured to) measure RS and/or SSBs periodically, which may be configured for NES capable WTRUs. A WTRU may determine that the serving cell is in a reduced power state (e.g., or an NES state) from the measured channel condition(s). A determination may be based on the measured channel condition(s) being less than a configured threshold, and/or based on the received SSB and/or RS (e.g., as a function of the sequence received, RS or SSB indices). A WTRU may apply an offset, for example, based on an indication or determination that PA power is reduced.

A WTRU may monitor for detection of an SSB or RS associated with NES, e.g., corresponding to a new PCI. A WTRU may determine that a serving cell is in an NES state or a power reduced state based on (e.g., upon) detection of an SSB or RS that corresponds to an NES PCI. The NES PCI may point to an alternate cell. The WTRU may determine the cell to handover to from the value of the new NES PCI detected. The WTRU may perform mobility to a target or CHO candidate cell based on (e.g., upon) detection of a PCI, e.g., based on/upon satisfying other preexisting mobility or CHO conditions (e.g., measurement of channel conditions at the target cell above a threshold). A WTRU may monitor for one or more PCIs (e.g., the PCI of the source cell, the PCI of the target cell, and/or the NES PCI). A WTRU may perform associated measurements, e.g., for a configured duration of time and/or based on (e.g., upon) detection of one or more triggers (e.g., as described herein). A WTRU may handover to cell with an SSB corresponding to the NES PCI, for example, if the cell is the same source cell with a reduced power state.

Mobility in inactive state may be triggered by a data transmission, such as a small data transmission (SDT). In some examples, a WTRU may be in an inactive state configured with small data transmission/reception. The WTRU may receive a handover command, an RRC reconfiguration, and/or an indication of one or more candidate cells to hand over to part of a small data TB or a multiplexed MAC CE in PDSCH. The WTRU may (e.g., determine to) handover to another candidate cell, for example, based on a property of the small data transmission payload received in Inactive state, based on (e.g., upon) receiving an availability state switch command from the network (e.g., during an SDT session), and/or based on the determined NES state associated with the cell that is ongoing through an availability state switch.

Inter-TRP handover may occur within a cell.

In some examples, a WTRU may receive an indication that reception of PDCCH transmission and/or PDSCH transmission using a transmission configuration index (TCI) state will be turned off (e.g., or turned on). An indication may be included in WTRU-group common signaling, such as a DCI received in a WTRU-group common search space, and/or in system information. An indication may be or may provide an indication of an availability state. A WTRU may receive (e.g., signaling indicating) an association between a TCI state with a TCI state group identity (e.g., or TRP identity). A WTRU may (e.g., alternatively) receive (e.g., signaling indicating) an association between a TCI state and an availability state. Signaling may be or may include an information element (IE) in a TCI state configuration or a MAC CE. A WTRU may (e.g., then) receive (e.g., from WTRU-group common signaling) an indication of a TCI state group identity and/or an indication that transmission will be turned on or off. The (e.g., exact) time when transmission may be turned off (e.g., or on) may be a fixed or configured time after reception of the signaling. Signaling may (e.g., alternatively) include an indication of the time when transmission may be turned off (e.g., or on), e.g., in terms of number of symbols or slots.

A WTRU may (e.g., based on receiving an indication that reception using a TCI state will be turned off) stop receiving PDCCH using a TCI state and/or may receive PDCCH from an alternate TCI state (e.g., at the indicated time). The alternate TCI state to use may be configured for each TCI state that is subject to being turned off. The WTRU may (e.g., also) stop monitoring beam failure detection resources associated with the TCI state to be turned off and/or may monitor (e.g., start monitoring) beam failure detection resources associated with the alternate TCI state.

A handover may be performed to a cell that is sleeping or in an NES state.

A WTRU may determine the availability state of a target cell, for example, prior to performing a handover procedure to the target cell (e.g., prior to initiating an RA procedure on it, prior to synchronizing to it, and/or prior to transmitting on uplink channels or signals). A WTRU may determine an availability state of the target cell, for example, based on an indication received in (e.g., as part of) the handover command or an indication from the source cell. For example, an RRC reconfiguration message may indicate an availability state associated with a target cell, associated uplink resources, associated DRX cycles, associated PRACH resources, associated SSB or alternative SSB cycles, and/or the subset of SSB(s) transmitted at the target cell. A WTRU may determine an availability state of a target cell, for example, from broadcast or SI signaling received from the cell itself (e.g., the target cell). For example, a WTRU may acquire system information (SI) or other SI to determine an availability state of a cell. The availability of a cell may be transmitted, for example, by PBCH or SI broadcast signaling. A WTRU may (e.g., implicitly) determine an availability state and/or a DL power operation state (e.g., reduced coverage, NES power efficient PA operation) of a target cell, for example, based on the reception of SSBs on the cell, and/or based on a property thereof. For example, a WTRU may determine an availability state, an NES state, and/or a power operation state based on (e.g., upon) reception of SSB(s) associated with NES, which may include, for example, one or more of the following: a stripped down SSB, a PSS-only SSB, an SSB transmitted using NES periodicity, and/or a subset of SSBs that correspond to the NES state.

A WTRU may determine an availability state at a source/serving cell, a candidate cell for HO, an alternate cell, and/or any other cell, for example, using one or more procedures described herein.

A WTRU may be configured with an NES cell validity time (e.g., via a timer). A time (e.g., timer) may be associated with one or more availability states associated with a cell. A time (e.g., timer) may be configured, for example, per carrier or per BWP. A WTRU may start tracking an NES cell validity time (e.g., via a timer), for example, following reception/detection of DL signal with the cell, e.g., with a signal strength above a threshold. A WTRU may (e.g., while the timer is running), assume a given availability state (e.g., ON for a period after SSB detection or a presence indication/signal). A WTRU may perform measurements (e.g., on SSBs or RS), for example, using default (e.g., legacy) settings while a time is being tracked (e.g., timer is running). A WTRU may (e.g., based on/upon expiry of the NES cell validity time (e.g., via a timer) determine whether (e.g., or assume) the cell is in a different NES/availability state. The WTRU may check for system information (SI), an availability state change command, and/or detect a presence signal associated with the cell for NES (e.g., prior to resuming regular measurements). The WTRU may use UL/DL resources associated with the cell, e.g., using the default non-NES state. The WTRU may restart the time (e.g., timer), for example, based on (e.g., upon) determining an availability state change for the associated cell (e.g., if the cell is not in an NES state), receiving a DL signal or channel from the channel, receiving an HO command form another cell for HO to the associated cell, and/or detecting an SSB or RS associated with the cell. The WTRU may trigger an RLF or SCG failure procedure upon expiry of the time (e.g., timer).

Random access (RA) may be performed in a cell that is sleeping or in an NES state.

A WTRU may receive (e.g., as part of an RRC reconfiguration/HO command) an indication for the timing or a period of time to measure SSBs at a target cell, and/or a value to apply for the NES cell validity time (e.g., timer). The WTRU may receive (e.g., as part of the RRC reconfiguration/HO command or other SI) an indication for the applicable ROs at the target cell or a serving cell, applicable SSBs/CSI-RS occasions, an NES candidateBeamRSList for BFR, and/or a differentiated/NES SSB to RO mapping, which may be applied, for example, based on (e.g., upon) a determination that the cell on which RA is performed is in a certain NES state.

Random access (RA) may be initiated on a cell in an NES state (e.g., including RA performed at a target cell for mobility). A WTRU may initiate a procedure for coverage enhanced RA, for example, by selecting a PRACH resource associated with msg1 and/or msg3 repetition, DFT-s-OFDM, and/or a CE spectrum shaping waveform for Msg3. A WTRU may perform an RA with coverage enhancement at the target cell (e.g., based on reception of a field in the HO command), for example, if there is an indication that the target cell is in a given NES state or a reduced PA power state, if there is an indication to perform RA using coverage enhancement (e.g., as part of the command), and/or if an RA resource associated with NES is indicated (e.g., as part of the command) and/or if an RRC reconfiguration is issued by the source cell. A WTRU may be configured with alternative parameters that may be used for an RA initiated on a cell in an NES state. Parameters may include, for example, one or more of the following: Tx power, power ramping step, backoff duration, PRACH resources, and/or preambleTransMax. A WTRU may be configured with alternative values that may be used for the random access response (RAR) window and/or the contention resolution timer, for example, if the cell on which RA is performed is determined to be in one or more availability/NES states.

A WTRU may receive configuration information indicating (e.g., be configured (e.g., in contention free RACH (CFRA) with) a certain preamble or RO partition associated with NES. A WTRU may determine (e.g., assume) that an NES SSB cycle (e.g., or NES SSBs) is used and/or may initiate an RA procedure using the NES parameters for RA (e.g., Tx power, power ramping step, etc.), for example, if the WTRU receives a PDCCH order with a PRACH partition. The availability state associated with the target cell may be indicated, for example, by the PDCCH order. The WTRU may (e.g., hence) use (e.g., only) PRACH resource(s) applicable to the cell's active availability state.

The WTRU may receive configuration information indicating (e.g., be configured with) one or more (e.g., dedicated) CFRA resources (e.g., by dedicated signaling, e.g., rach-ConfigDedicated). The CFRA resource(s) may be used, for example, if the WTRU has buffered data from one or more logical channels (LCHs) or data radio bearers (DRBs) that may be associated with low latency, associated with a QoS flow (e.g., configured within a latency budge below a threshold), and/or if the LCH with buffered data is configured to allow the WTRU to use the CFRA resources.

A WTRU may postpone a preamble transmission, for example, if none of the SSBs are measured with an RSRP above the configured threshold during a PRACH resource selection part of an RA procedure, e.g., based on/upon determining that the cell on which RA is performed is in NES state. A WTRU may delay a RACH preamble transmission, for example, until an SSB is measured above the RSRP threshold and/or until the NES SSB/PRACH occasions occur following a DL signal detection from the same cell or gNB. A WTRU may (e.g., consequently) not increment a preamble transmission counter and/or the preamble power ramping counter, for example, if the preamble was not transmitted due to NES state and/or due to not detecting an SSB above the configured threshold. A WTRU may increment the preamble transmission counter and/or the preamble power ramping counter, for example, (e.g., only) if an SSB was detected with a signal strength above the configured threshold, e.g., within a certain period of timer prior to the RO. A WTRU (e.g., in IDLE or Inactive state) may avoid using PRACH occasions that follow a failure to detect an SSB above an (e.g., a configured) RSRP threshold.

A RACH may be initiated by an NES group handover.

An RA procedure may be initiated by a handover caused by NES (e.g., based on one or more CHO conditions or mobility methods, an HO caused by coverage loss due to NES, and/or an HO caused by a cell turning off). A WTRU may be configured with an RA type and/or a PRACH resource type to use, which may include, for example, one or more of the following: an indication whether the PRACH resource is a 2-step or 4-step RA resource, an indication whether the PRACH resource is coverage enhanced, an indication whether the PRACH resource is associated with a given slice, an indication of one or more applicable RRC state(s), and/or an indication of an alternative value for an msgA-RSRP-Threshold.

An RA procedure may be initiated by a handover caused by NES (e.g., based on one or more CHO conditions, an HO caused by coverage loss due to NES, and/or an HO caused by a cell turning off). A WTRU may use contention based resources to access a target cell, e.g., while a timer is running (e.g., T304, the new NES mobility timer, and/or the NES cell validity timer). The WTRU may fall back to CFRA resources, for example, if the timer expires, after a number of CBRA preamble transmissions, and/or if the CBRA procedure is not (e.g., yet) successful (e.g., an RAR was not received and/or a contention resolution was not received).

For example, a WTRU in RRC Inactive may initiate an RA to resume a suspended connection and/or an SDT may be (pre) configured or (pre) determined to use 2-step CBRA resources or CFRA resources. A WTRU may determine whether to use 2-step RA, 4-step RA, CBRA, or CFRA, for example, based on at least one of the following: a type of WTRU(s), WTRU capability (e.g., Redcap/URLLC), a type of DRBs resumed (e.g., SDT DRBs, DRBs configured with low latency packet delay budgets (PDB) s), the WTRU's NES group, QoS, latency requirements, power constraints, the availably states associated with the source and target cells, and/or the upcoming state transition timing.

A WTRU may receive an indication (e.g., from a gNB) indicating which carrier type to use (e.g., non-supplemental uplink (SUL) or SUL), which RACH resource to use, and/or which type of RACH to use (e.g., 2-step vs. 4-step).

Carrier switching and/or low-energy operation may be provided.

SCell operation may be implemented without SSB transmission/cross carrier synchronization.

A WTRU may acquire a secondary serving cell's downlink timing, preform procedures related to initial access, perform SI acquisition, and/or perform synchronization based on a Pcell, for example, if an SSB (e.g., or a subset of SSBs) were not detected (e.g., if SS-RSRP is lower than a configured threshold and/or if the WTRU is not able to or does not detect the sequence associated with the PSS and/or the SSS transmission).

A WTRU may receive (e.g., from a Pcell) a configuration or a reconfiguration of an Scell availably state and/or an associated SSB, CSI-RS. For example, a WTRU may receive a reconfiguration of the Scell's SSB periodicity and/or an indication whether the Scell's SSB periodicity is transmitted from the Pcell or another associated cell (e.g., another Scell or a cell in a different cell group). The WTRU may receive an indication and/or a configuration of a downlink timing offset to be used for Scell DL timing, for example, if a Pcell and/or other associated cell was used to perform initial access and/or acquire DL timing. The offset value may be scaled or chosen (e.g., determined, selected), for example, based on the frequency gap between the center frequency of the Scell and the cell on which DL synchronization was performed (e.g., an associated Pcell).

A WTRU may use resources and/or activate a secondary cell (Scell) without SSBs, for example, based on one or more of the following conditions. A WTRU may determine, e.g., if none of the conditions are satisfied, that the Scell is not active, dormant, or not detected. The WTRU may not perform regular measurements on the Scell and/or may not perform uplink or downlink transmissions on the Scell.

A WTRU may use resources and/or may activate a secondary cell without SSBs, for example, if the WTRU is synchronized to the Pcell or the SpCell.

A WTRU may use resources and/or activate a secondary cell without SSBs, for example, if the Scell is within the same frequency band as the Pcell and/or the cell from which synchronization was attained.

A WTRU may use resources and/or activate a secondary cell without SSBs, for example, if separation in the frequency domain between the Scell and the Pcell and/or the cell from which synchronization was attained does not exceed a predefined or configured maximum frequency gap.

A WTRU may use resources and/or activate a secondary cell without SSBs, for example, if the WTRU determines a change in availability state associated with the Scell, the Pcell, the NES Pcell, and/or another cell from which synchronization was attained. For example, a WTRU may use an Scell without SSBs based on reception of an indication (e.g., from the NW) indicating a certain NW activity level on the Pcell or the associated Scell or based on detection of a presence signal associated with the Pcell or the Scell.

A WTRU may use resources and/or activate a secondary cell without SSBs, for example, based on reception of an indication (e.g., from the gNB), e.g., within a time period of the reception, such as while the Scell deactivation timer or another timer is running. An indication may be, for example, a DCI or PDCCH signaling, e.g., indicating one or more parameters to use for cross carrier synchronization.

A WTRU may use resources and/or activate a secondary cell without SSBs, for example, if the WTRU is scheduled (e.g., cross carrier) to use or monitor a DL and/or UL resource on the Scell.

A WTRU may use resources and/or activate a secondary cell without SSBs, for example, if the WTRU is in DRX active time and/or on duration for the Scell and/or other related cells (e.g., the Pcell, the NES Pcell, and/or a cell from which synchronization was attained).

A WTRU may use resources and/or activate a secondary cell without SSBs, for example, if a time (e.g., timer) has expired (e.g., a beam failure detection timer).

A WTRU may de-activate the SCell without SSBs, for example, if one or more conditions (e.g., as described herein) are not met. The WTRU may stop monitoring and/or measuring for DL signals (e.g., PDCCH, RS, SSBs) and/or resources (e.g., PDSCH) associated with an SCell without SSB transmissions (e.g., at least for the period that SCell is operating without SSB transmission), for example, if one or more of the of the conditions are not met. The WTRU may stop using UL resources (e.g., PRACH, PUCCH, PUSCH) and/or stop transmitting uplink signals (e.g., UCI, PRACH, SRS, pSRS) associated with an SCell without SSB transmissions (e.g., at least for the period that SCell is operating without SSB transmission), for example, if one or more of the of the conditions are not met.

NES PCell switching may be implemented.

In some examples (e.g., deployment scenarios), one or more (e.g., some) WTRUs in a service area may have a different PCell than other WTRUs. For example, one or more WTRUs may have a different PCell and the same SCell. In some examples, a PCell for one WTRU may be an SCell for another WTRU served by the same gNB. The WTRU may receive a PCell switching L1 indication (e.g., a group common command or DCI) and/or L2 signaling (e.g., broadcast signaling, MAC CE, or a PDSCH). A PCell switching indication may indicate to multiple (e.g., all) WTRUs served by the cell group to consider a certain (pre) configured or (pre) determined cell as the PCell (e.g., the cell on which certain SSBs are transmitted). For example, a WTRU may (e.g., based on/upon reception of a PCell switching command) activate serving cell x (e.g., the NES PCell) and consider it to be the primary cell, and/or may consider another cell y (e.g., that was a PCell to an SCell) to be the primary cell. In some examples, x and y may be configured in RRC and/or in broadcast signaling. The WTRU may perform PCell switching, for example, if at least one of the following conditions are met: (a) successfully receiving a PCell switching command, (b) decoding an SSB and/or CSI-RS associated with the new active PCell (e.g., the NES PCell), (c) measuring channel conditions above a configured threshold, e.g., on the new active PCell (e.g., the NES PCell), and/or (d) expiry of a timer and/or a time period without reception of a DL signal from a cell (e.g., which may be considered as an SCell or de-activated based on/upon expiry of the timer). The WTRU may fallback to using the last serving PCell, for example, if the WTRU mis-detects DL signaling from the new PCell (e.g., the NES PCell).

A WTRU may receive an indication from a gNB to re-establish security keys and/or to indicate which DL and/or UL resources may be used on the activated PCell and/or other activated NES cell, e.g., based on/upon reception of NES PCell switching command. The WTRU may re-use a subset of configurations that may be configured from the SpCell for the NES PCell and/or other activated cell for NES purposes.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-16. (canceled)

17. A wireless transmit/receive unit (WTRU) comprising:
a processor configured to:
receive configuration information that indicates at least one handover condition associated with network energy savings (NES);
receive downlink control information (DCI) from a source cell that indicates an NES mode, wherein the DCI is scrambled with a group identity associated with the NES mode;
determine that a target cell satisfies the at least one handover condition associated with NES; and
based at least on the DCI and the determination that the target cell satisfies the at least one handover condition associated with NES, perform a handover to the target cell.

18. The WTRU of claim 17, wherein the determination that the target cell satisfies the at least one handover condition associated with NES is based on a determination that a measurement associated with the target cell is greater than a threshold.

19. The WTRU of claim 17, wherein the determination that the target cell satisfies the at least one handover condition associated with NES is based on a determination that a measurement associated with the source cell is below a first threshold and based on a determination that a measurement associated with the target cell is greater than a second threshold.

20. The WTRU of claim 17, the determination that the target cell satisfies the at least one handover condition associated with NES is based on a determination that a measurement associated with the target cell is greater by at least a threshold than a measurement associated with the source cell.

21. The WTRU of claim 20, wherein the threshold is a first threshold if the target cell and the source cell are operating using a non-NES mode, wherein the threshold is a second threshold if the target cell is operating using the non-NES mode and the source cell is operating using a power saving mode, and wherein the threshold is a third threshold if the source cell has turned off and if the target cell is operating using the non-NES mode.

22. The WTRU of claim 17, wherein the NES mode is associated with an activation of cell discontinuous reception (DRX) or a cell turn off.

23. The WTRU of claim 17, wherein the at least one handover condition associated with NES is associated with one of a NES-specific conditional handover event or a NES-specific conditional handover execution condition.

24. A method comprising:
receiving configuration information that indicates at least one handover condition associated with network energy savings (NES);
receiving downlink control information (DCI) from a source cell that indicates an NES mode, wherein the DCI is scrambled with a group identity associated with the NES mode;
determining that a target cell satisfies the at least one handover condition associated with NES; and
based at least on the DCI and the determination that the target cell satisfies the at least one handover condition associated with NES, performing a handover to the target cell.

25. The method of claim 24, wherein the determination that the target cell satisfies the at least one handover condition associated with NES is based on a determination that a measurement associated with the target cell is greater than a threshold.

26. The method of claim 24, wherein the determination that the target cell satisfies the at least one handover condition associated with NES is based on a determination that a measurement associated with the source cell is below a first threshold and based on a determination that a measurement associated with the target cell is greater than a second threshold.

27. The method of claim 24, the determination that the target cell satisfies the at least one handover condition associated with NES is based on a determination that a measurement associated with the target cell is greater by at least a threshold than a measurement associated with the source cell.

28. The method of claim 27, wherein the threshold is a first threshold if the target cell and the source cell are operating using a non-NES mode, wherein the threshold is a second threshold if the target cell is operating using the non-NES mode and the source cell is operating using a power saving mode, and wherein the threshold is a third threshold if the source cell has turned off and if the target cell is operating using the non-NES mode.

29. The method of claim 24, wherein the NES mode is associated with an activation of cell discontinuous reception (DRX) or a cell turn off.

30. The method of claim 24, wherein the at least one handover condition associated with NES is associated with one of a NES-specific conditional handover event or a NES-specific conditional handover execution condition.
